(19) United States
(12) Patent Application Publication
(10) Pub. No.: US 2024/0087483 A1
(43) Pub. Date: Mar. 14, 2024

(54) VIDEO DISPLAY DEVICE AND METHOD FOR ASSEMBLING VIDEO DISPLAY DEVICE

(71) Applicant: Mitsubishi Electric Corporation, Tokyo (JP)

(72) Inventors: Yohei ITO, Tokyo (JP); Shigeru UTSUMI, Tokyo (JP); Sohei SAMEJIMA, Tokyo (JP); Satoru KIRIDOSHI, Tokyo (JP)

(73) Assignee: Mitsubishi Electric Corporation, Tokyo (JP)

(21) Appl. No.: 18/270,220

(22) PCT Filed: Jan. 22, 2021
(86) PCT No.: PCT/JP2021/002231

§ 371 Date: Jun. 29, 2023

(51) Int. Cl. G09F 9/302; G09F 9/33

(52) U.S. Cl. CPC G09F 9/3026; G09F 9/33

(57) ABSTRACT

A video display device (100) includes a board (1) on which light emitters (10) to emit light are mounted and a support (2) including a support film (20) receiving the board (1). The board (1) is installable to extend in a gravitational direction. The support (2) has an opening (5). The support film (20) has an installation surface on which the board (1) is installed and a non-installation surface opposite to the installation surface. The opening (5) in the support (2) penetrates the support (2) from the installation surface to the non-installation surface of the support film (20). The board (1) has an upper end fixed to the installation surface of the support film (20) and a lower end extending through the opening (5) and placed on the non-installation surface of the support film (20).

### TECHNICAL FIELD

The present disclosure relates to a video display device and a method for assembling the video display device.

### BACKGROUND ART

A known flat display device includes a resin case accommodating a rigid board on which light emitters such as light-emitting diodes (LEDs) are mounted.

Another known surface emitter display (see, for example, Patent Literature 1) includes a surface emitter attached to a sheet. The surface emitter includes multiple light-emitting modules arranged parallel to each other, each including multiple LEDs mounted on an elongated strip-shaped board. The surface emitter display described in Patent Literature 1 includes the light-emitting modules and the sheet having many air vents formed from a windable flexible material.

### CITATION LIST

### Patent Literature

Patent Literature 1: Unexamined Japanese Patent Application Publication No. 2019-101350

### SUMMARY OF INVENTION

### Technical Problem

However, the above flat display device and the housing accommodating the flat display device have heavy loads to maintain strength and rigidity against a wind load.

Although the technique described in Patent Literature 1 can release wind through the air vents in the sheet, the strip-shaped board may be damaged with wind loads.

In response to the above issue, an objective of the present disclosure is to provide a video display device and a method for assembling the video display device that can reduce damage to the board.

### Solution to Problem

A video display device according to an aspect of the present disclosure includes a board on which light emitters to emit light are mounted and a support including a support film receiving the board. The board is installable to extend in a gravitational direction. The support has an opening. The support film has an installation surface on which the board is installed and a non-installation surface opposite to the installation surface. The opening in the support extends through the support from the installation surface to the non-installation surface of the support film. The board has an upper end fixed to the installation surface of the support film and a lower end extending through the opening and placed on the non-installation surface of the support film.

A method for assembling a video display device according to an aspect of the present disclosure includes installing a first support including a first support film to extend in a gravitational direction, and installing, below the first support in the gravitational direction, a second support including a second support film to extend in the gravitational direction and to cause an upper end of the second support film to face a lower end of the first support film across a first opening. The first support film has an installation surface on which a first board is installable and a non-installation surface opposite to the installation surface. The method includes fixing an upper end of the first board to the first support film, and placing a lower end of the first board through the first opening to be on the non-installation surface of the second support film. The first opening defined by the first support and the second support extends from the installation surface to the non-installation surface.

### Advantageous Effects of Invention

The technique according to the above aspects of the present disclosure can reduce damage to the board.

### BRIEF DESCRIPTION OF DRAWINGS

FIG. 1 is a schematic front view of a video display device according to Embodiment 1;

FIG. 2 is a schematic side view of the video display device according to Embodiment 1;

FIG. 3 is a schematic front view of a part of a support film in the video display device according to Embodiment 1;

FIG. 4 is a cross-sectional side view of a part of the video display device according to Embodiment 1;

FIG. 5 is a schematic front view of a part of the video display device according to Embodiment 1;

FIG. 6 is a cross-sectional side view of a part of the video display device according to Embodiment 1;

FIG. 7 is a cross-sectional side view of a part of another video display device according to Embodiment 1;

FIG. 8 is a schematic front view of a part of a support film in another video display device according to Embodiment 1;

FIG. 9 is a schematic front view of a part of a board in the other video display device according to Embodiment 1;

FIG. 10 is a schematic side view of a part of another video display device according to Embodiment 1;

FIG. 11 is a schematic front view of a part of the other video display device according to Embodiment 1;

FIGS. 12A and 12B are schematic diagrams of parts of a support film in another video display device according to Embodiment 1;

FIG. 13 is a schematic front view of a video display device according to Embodiment 2;

FIG. 14 is a schematic front view of the video display device according to Embodiment 2;

FIG. 15 is a schematic side view of the video display device according to Embodiment 2;

FIGS. 16A and 16B are diagrams each describing a method for assembling another video display device according to Embodiment 2;

FIG. 17 is a schematic front view of a part of another video display device according to Embodiment 2;

FIG. 18 is a cross-sectional side view of a part of a video display device according to an embodiment of the present disclosure;

FIG. 19 is a cross-sectional side view of a part of a video display device according to an embodiment of the present disclosure;

FIG. 20 is a cross-sectional side view of a part of a video display device according to an embodiment of the present disclosure;

FIG. 21 is a cross-sectional side view of a part of a video display device according to an embodiment of the present disclosure;

FIG. 22 is a cross-sectional side view of a part of a video display device according to an embodiment of the present disclosure;

FIG. 23 is a schematic front view of a part of a video display device according to an embodiment of the present disclosure;

FIG. 24 is a cross-sectional view of a part of a video display device according to an embodiment of the present disclosure;

FIG. 25 is a cross-sectional view of a part of a video display device according to an embodiment of the present disclosure;

FIG. 26 is a cross-sectional view of a part of a video display device according to an embodiment of the present disclosure;

FIG. 27 is a cross-sectional view of a part of a video display device according to an embodiment of the present disclosure;

FIG. 28 is a cross-sectional side view of a part of a video display device according to an embodiment of the present disclosure;

FIG. 29 is a schematic front view of a part of a video display device according to an embodiment of the present disclosure; and

FIG. 30 is a schematic front view of a part of the video display device according to the embodiment of the present disclosure.

### DESCRIPTION OF EMBODIMENTS

Embodiments of the present disclosure are described below in detail with reference to the drawings. The present disclosure is not limited to the embodiments described below and may be changed as appropriate without departing from the spirit and scope of the present disclosure. The same reference numerals denote components having substantially the same functions herein and in the drawings, and such components are not described repeatedly. In the drawings, the structures of devices and the shapes of components are merely illustrated schematically. The relative dimensions and the relative positions of the components in each drawing may not accurately illustrate the dimensional relationship and the positional relationship between actual components.

### Embodiment 1

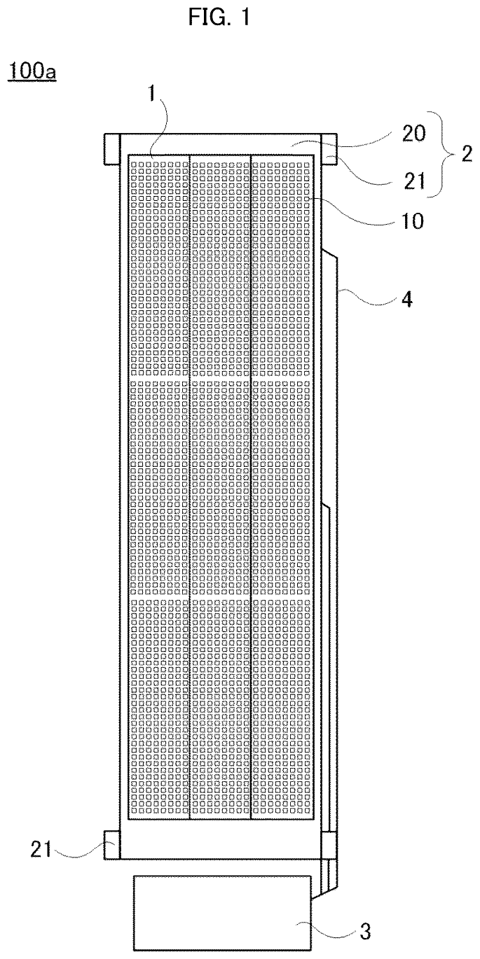

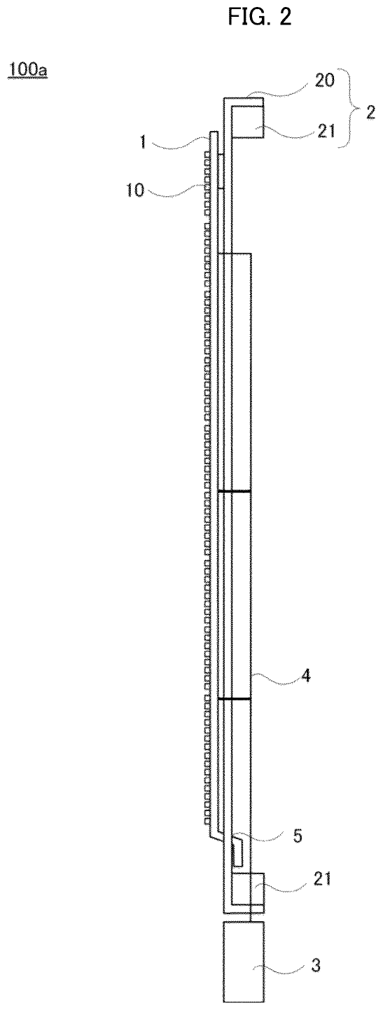

FIG. 1 is a schematic front view of a video display device 100a according to Embodiment 1. FIG. 2 is a schematic side view of the video display device 100a according to Embodiment 1. The video display device 100a includes boards 1 and a support 2 supporting the boards 1. The support 2 includes a support film 20 and support members 21 holding the support film 20. The video display device 100a also includes a power controller 3 that supplies power and video signals to the boards 1 and a cable 4 connecting the boards 1 to the power controller 3. The details are described below.

The boards 1 are described first. The boards 1 are installed on the support film 20 in the support 2 to extend in the gravitational direction. The video display device 100a includes three boards 1 arranged in the lateral direction of the support film 20. Light emitters 10 that emit light are mounted on the surfaces of the boards 1 opposite to the surfaces facing the support film 20.

The base material for the boards 1 is selectable from, for example, polyimide, polyethylene terephthalate (PET), a liquid crystal polymer (LCP), and silicone. The boards 1 may be flexible to further reduce damage.

The display pattern of each light emitter 10 mounted on the boards 1 is controlled by the power controller 3. The boards 1 display information including, for example, a preset advertisement. The boards 1 can display any display pattern by, for example, turning on or off each light emitter 10 or changing the colors of light emitted from each light emitter 10.

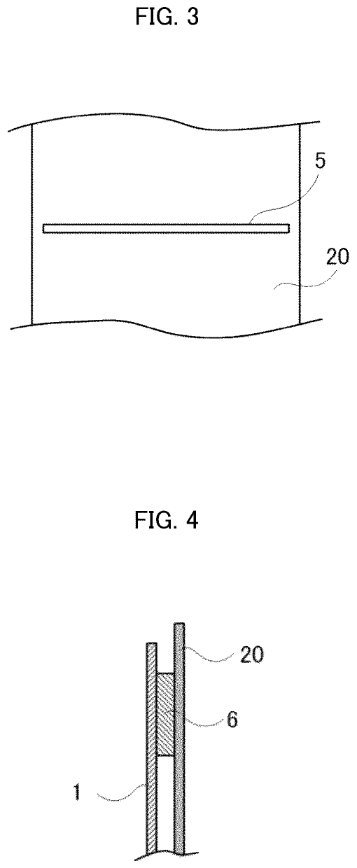

The support 2 is now described. The support 2 includes the support film 20 and the support members 21 holding the support film 20. For the video display device 100a, the surface of the support film 20 on which the boards 1 are installed is hereafter referred to as an installation surface, and the surface opposite to the installation surface is referred to as a non-installation surface. FIG. 3 is a schematic front view of a part of the support film 20 in the video display device 100a according to Embodiment 1. As illustrated in FIGS. 2 and 3, the support film 20 has an opening 5 penetrating the support film 20 from the installation surface to the non-installation surface. The opening 5 is described later in detail.

The support members 21 are located one on each of the top and the bottom of the support film 20 in the gravitational direction. The support member 21 on the top is referred to as an upper support member, and the support member 21 at the bottom is referred to as a bottom support member. The support film 20 extends in the gravitational direction. The support film 20 has the upper end held by the upper support member and the lower end held by the bottom support member. The support film 20 is held by the upper and bottom support members under tension. Although the video display device 100a includes the single support film 20 receiving the three boards 1 arranged laterally, the support film 20 may receive any number of boards 1, such as one or more boards 1. In some embodiments, the boards 1 may be arranged vertically on the support film 20.

The support film 20 may be formed from a resin or a fiber coated with a resin. Examples of the material of the support film 20 may include a glass fiber coated with a fluororesin, a glass fiber coated with a polyvinyl chloride (PVC) resin, a synthetic fiber such as a polyester fiber coated with PVC, and a membrane-structure film of a fluororesin film such as an ethylene tetrafluoroethylene (ETFE) film.

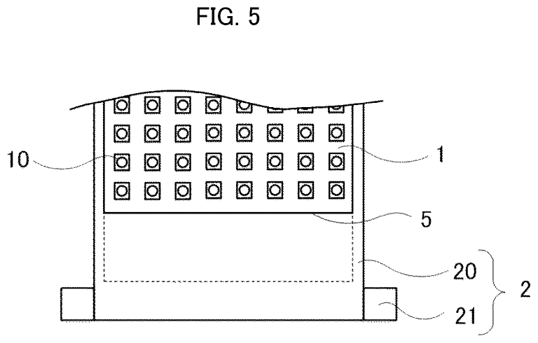

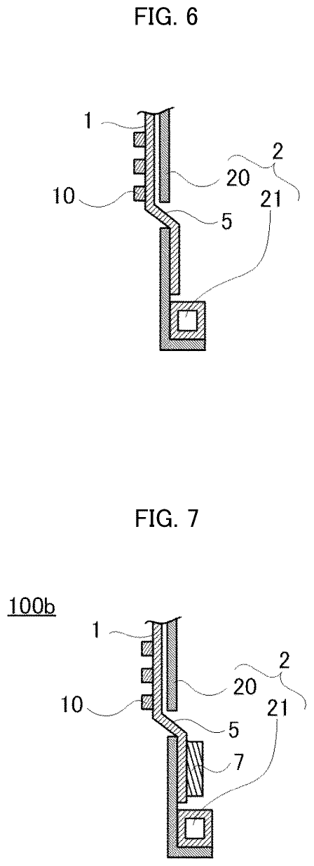

A method for installing the boards 1 on the support film 20 is now described. FIG. 4 is a cross-sectional side view of a part of the video display device 100a according to Embodiment 1. FIG. 5 is a schematic front view of a part of the video display device 100a according to Embodiment 1. FIG. 6 is a cross-sectional side view of a part of the video display device 100a according to Embodiment 1. FIG. 5 is a diagram of one of the boards 1 installed on the support film 20 illustrated in FIG. 3. A broken line in FIG. 5 indicates the board 1 placed on the non-installation surface of the support film 20.

As illustrated in FIG. 4, the upper end of each board 1 is fixed to the installation surface of the support film 20 with an adhesive 6. Examples of the adhesive 6 include a pressure-sensitive adhesive, a structural adhesive, and double-sided adhesive tape.

As illustrated in FIGS. 5 and 6, the lower end of each board 1 extends from the installation surface to the non-installation surface through the opening 5 in the support film 20. The lower end of each board 1 is placed on the non-installation surface of the support film 20.

More specifically, each board 1 has the upper end fixed to the installation surface of the support film 20 and the lower end extending from the installation surface to the non-installation surface of the support film 20 through the opening 5 in the support film 20 to be placed on the non-installation surface. Thus, the video display device 100a holds each board 1 between the installation surface and the non-installation surface of the support film 20. This reduces separation or detachment of the lower end of each board 1 from the support film 20 due to, for example, wind. Although being held between the installation surface and the non-installation surface of the support film 20, the lower end of each board 1 in the video display device 100a is unfixed to the installation surface or to the non-installation surface. This can suppress transmission of deformation of the support film 20 to the board 1, thus reducing breakage of the board 1.

As described above, the video display device 100a includes the boards 1 receiving the light emitters 10 that emit light arranged to extend in the gravitational direction and the support 2 having an opening and including the support film 20 on which the boards 1 are installed. The support film 20 has the installation surface receiving the boards 1 and the non-installation surface opposite to the installation surface. The opening in the support 2 extends through the support film 20 from the installation surface to the non-installation surface. Each board 1 has the upper end fixed to the installation surface of the support film 20 and the lower end extending through the opening and placed on the non-installation surface of the support film 20.

The video display device 100a with the above structure can reduce damage to the boards 1.

FIG. 7 is a cross-sectional side view of a part of another video display device 100b according to Embodiment 1. As illustrated in FIG. 7, a weight 7 is attached to the lower end of each board 1 on the non-installation surface of the support film 20. The other components of the video display device 100b are the same as the components of the video display device 100a according to Embodiment 1. The structure can further reduce detachment of the lower end of each board 1 from the support film 20 and reduce damage to the board 1. Although the example of FIG. 7 includes the weight 7 at the lower end of the board 1, other retainers such as magnets may be attached to the non-installation surface of the support film 20 and the board 1.

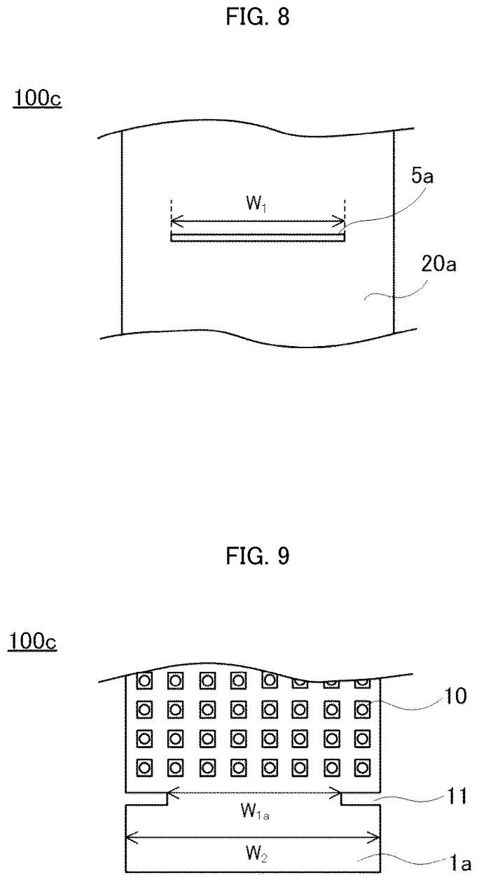

FIG. 8 is a schematic front view of a part of a support film 20a in another video display device 100c according to Embodiment 1. FIG. 9 is a schematic front view of a part of a board 1a in the video display device 100c according to Embodiment 1. As illustrated in FIG. 8, a width W₁ is the lateral width of an opening 5a in the support film 20a in the video display device 100c. As illustrated in FIG. 9, the board 1a has recesses 11 on the left and right edges. The recesses 11 extend laterally inward in the board 1a. A width W₁ a is the lateral width of the board 1 in a portion including the recesses 11, and a width W₂ is the lateral width of the board 1 in a portion not including the recesses 11. The width W₁ₐ including the recesses 11 is shorter than the width W₂. When the width W₁ of the opening 5a in the support film 20a is equal to the width W₁ a of the board 1a, the support film 20a can be placed in the recesses 11 in the board 1a to allow the opening 5a in the support film 20a to hold the board 1a. This structure can further reduce separation and detachment of the lower end of the board 1a from the support film 20a. In this example, the width W₁ of the opening 5a is equal to the width W₁ a between the recesses 11 in the board 1. In some embodiments, the width W₁ a may be shorter than the width W₁ when the widths W₁ and W₁ a are shorter than the width W₂ and the opening 5a can hold the board 1. The corners of the recesses 11 in the board 1 may have curvatures, or may have arc shapes. This can reduce stress concentrated on the recesses 11.

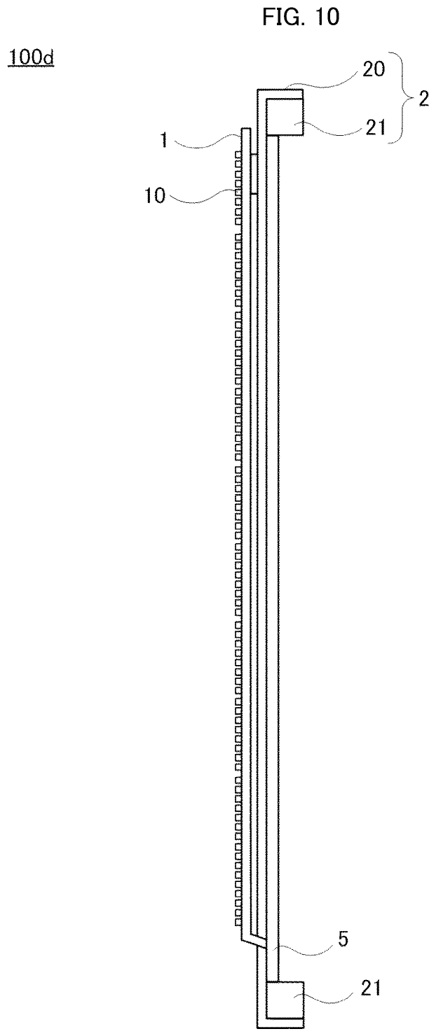

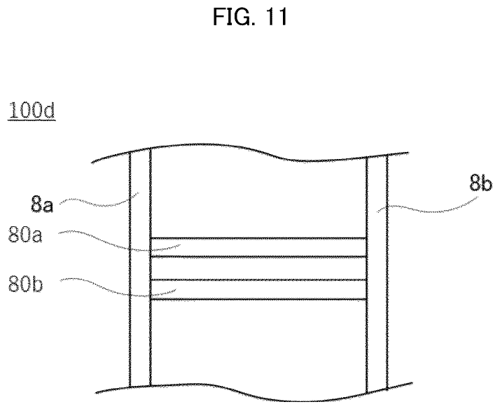

FIG. 10 is a schematic side view of a part of another video display device 100d according to Embodiment 1. In FIG. 10, the power controller 3 and the cable 4 are not illustrated. The power controller 3 and the cable 4 may not also be illustrated in the subsequent figures. FIG. 11 is a schematic front view of a part of the video display device 100d according to Embodiment 1. The support 2 in the video display device 100d includes a pair of side frames 8a and 8b (hereafter collectively referred to as side frames 8) at the left and right edges of the non-installation surface of the support film 20. The side frame 8a and the side frame 8b extend in the gravitational direction along the support film 20. The side frames 8 serving as side supports support the support film 20 to reduce deformation of the support film 20 under an external force. The support film 20 may be bonded to the side frames 8 or fixed to the side frames 8 with, for example, strings. As illustrated in FIG. 11, the support 2 in the video display device 100d includes an auxiliary frame 80a and an auxiliary frame 80b (hereafter collectively referred to as auxiliary frames 80) connecting the left and right side frames 8. The auxiliary frames 80 extend in a direction crossing the side frames 8. Thus, the video display device 100d can further reduce deformation of the support film 20 under an external force. Although the video display device 100d includes the two auxiliary frames 80 in the example of FIG. 11, the video display device 100d may include one auxiliary frame 80 or more than two auxiliary frames 80. The auxiliary frames 80 may be fixed to the support film 20, or may not be fixed to the support film 20 when the side frames 8 can reduce deformation of the support film 20 under an external force. In this case, the video display device 100d can enhance the strength of the support 2 using the auxiliary frames 80.

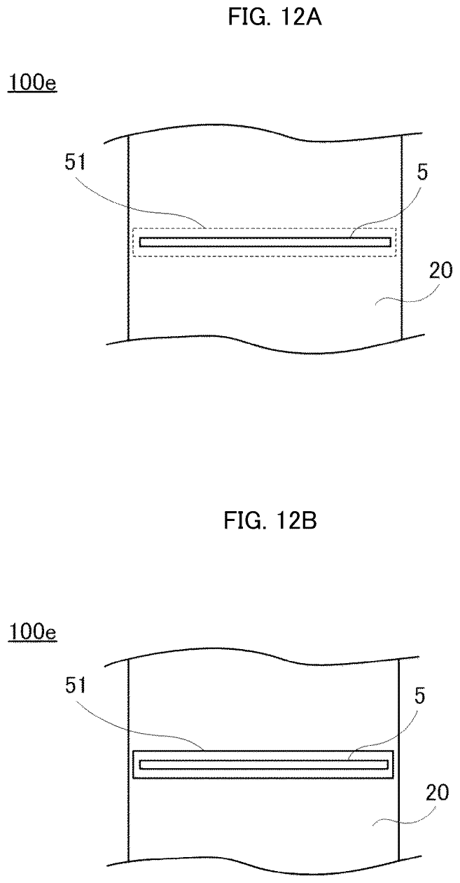

FIGS. 12A and 12B are schematic diagrams of parts of a support film 20 in another video display device 100e according to Embodiment 1. FIG. 12A is a diagram of the support film 20 as viewed from the installation surface side. FIG. 12B is a diagram of the support film 20 as viewed from the non-installation surface side. The support film 20 in the video display device 100e has a support film stiffener 51 at the periphery of the opening 5 on the non-installation surface of the support film 20. In FIG. 12A, the broken line indicates the position of the support film stiffener 51 unviewable on the non-installation surface. The support film stiffener 51 on the support film 20 enhances the strength of the opening 5 in the support film 20 and reduces breakage of the support film 20 under stress concentration. The support film stiffener 51 may be formed from, for example, the same material as the support film 20 or may be formed from a metal. The support film stiffener 51 may be located on the installation surface of the support film 20.

Although the opening 5 in the support film 20 has right-angle corners in Embodiment 1, the opening 5 may have curved corners. This structure can reduce stress concentrated on the opening 5.

### Embodiment 2

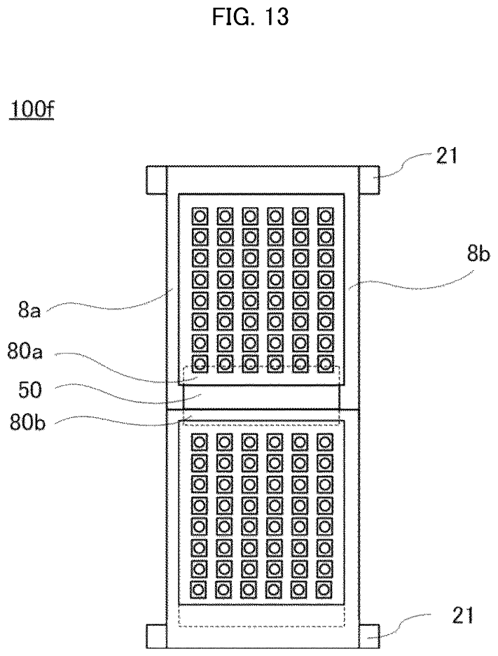

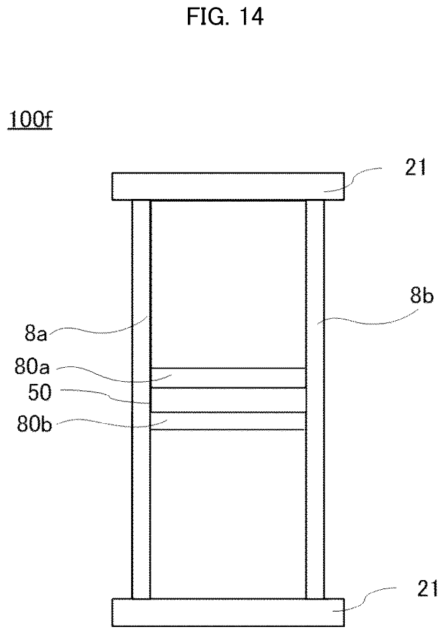

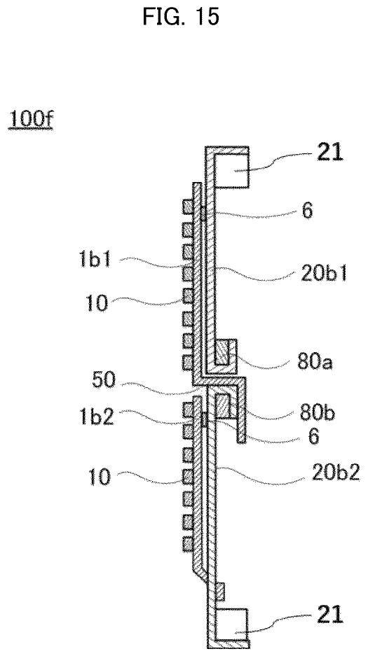

FIGS. 13 and 14 are schematic front views of a video display device 100f according to Embodiment 2. FIG. 15 is a schematic side view of the video display device 100f according to Embodiment 2. FIG. 14 is a diagram of the video display device 100f in FIG. 13 from which a support film 20b1 serving as a first support film, a support film 20b2 serving as a second support film, a first board 1b1, and a second board 1b2 are removed. In FIG. 14, the auxiliary frame 80a, the auxiliary frame 80b, and the lower end of the board 1b1 are covered with the support film 20b1 and the support film 20b2 and are indicated by broken lines. In FIGS. 13 to 15, the components having the same reference numerals as the components of the video display device 100d according to Embodiment 1 denote the same or corresponding components of the video display device 100d according to Embodiment 1, and such components are not described in detail.

As illustrated in FIG. 13, the video display device 100f includes the board 1b1 on the support film 20b1 and the board 1b2 on the support film 20b2. The side frame 8a is arranged at the left edges of the support film 20b1 and the support film 20b2. The side frame 8b is arranged at the right edges of the support film 20b1 and the support film 20b2. The upper end of the support film 20b1 is held by one support member 21, whereas the lower end of the support film 20b1 is held by the auxiliary frame 80a illustrated in FIG. 14. The upper end of the support film 20b2 is held by the auxiliary frame 80b illustrated in FIG. 14, whereas the lower end of the support film 20b2 is held by the other support member 21. The support 2 (not illustrated in FIGS. 13 to 15) in the video display device 100f includes the support film 20b1, the support film 20b2, the support members 21, the side frame 8a, the side frame 8b, the auxiliary frame 80a, and the auxiliary frame 80b.

As illustrated in FIG. 14, the auxiliary frame 80a and the auxiliary frame 80b in the video display device 100f extend across the side frame 8a and the side frame 8b to connect the side frame 8a and the side frame 8b. The auxiliary frame 80a and the auxiliary frame 80b are arranged in the direction crossing the side frame 8a and the side frame 8b. The auxiliary frame 80a and the auxiliary frame 80b are spaced from each other across a gap in the gravitational direction. This gap serves as an opening 50 in the video display device 100f. As in the opening 5 in Embodiment 1, the opening 50 is formed through the support film 20 from the installation surface to the non-installation surface. The video display device 100f thus has the opening 50 defined by the auxiliary frame 80a and the auxiliary frame 80b.

As illustrated in FIG. 15, the lower end of the support film 20b1 covers the auxiliary frame 80a, and the upper end of the support film 20b2 covers the auxiliary frame 80b. In the video display device 100f, the lower end of the support film 20b1 and the upper end of the support film 20b2 face each other. The lower end of the support film 20b1 and the upper end of the support film 20b2 cover the auxiliary frames 80 in the example illustrated in FIG. 15. In some embodiments, the auxiliary frames 80 may be left uncovered when the upper and lower ends of each of the support film 20b1 and the support film 20b2 can be placed on the support member 21 and the auxiliary frame 80 or on the auxiliary frames 80 under tension.

As illustrated in FIG. 15, in the video display device 100f, the lower end of the board 1b1 extends through the opening 50 to be placed on the non-installation surface of the support film 20b2. The lower end of the board 1b2 may extend through the opening 50 defined by the auxiliary frames 80 between the support film 20b2 and another support film 20 (not illustrated) located below the support film 20b2, and may be placed on the non-installation surface of the support film 20 below the support film 20b2. When no board 1 is below the board 1b2, or when the support film 20b2 is the lowest support film 20 in the video display device 100f, the support film 20b2 may have the opening 5 described in the Embodiment 1. This structure allows the lower end of the board 1b2 to extend through the opening 5 to be placed on the non-installation surface of the support film 20b2.

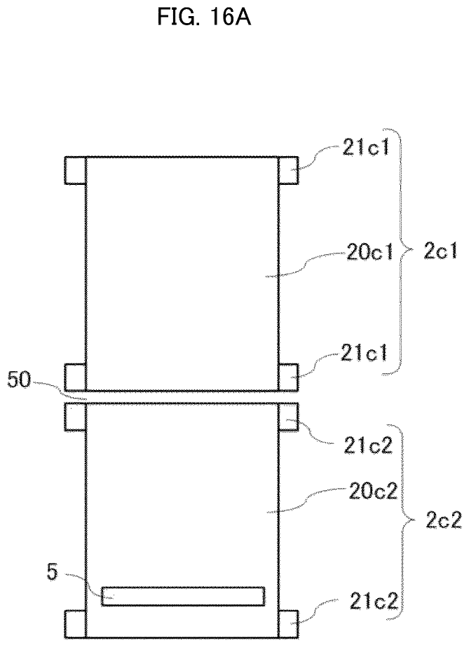

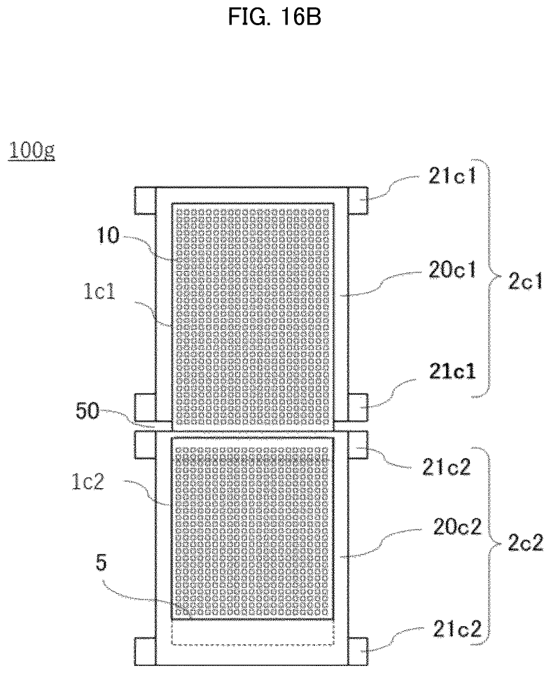

A method for assembling a video display device 100g is now described. FIGS. 16A and 16B are diagrams illustrating the method for assembling the video display device 100g according to Embodiment 2. In FIG. 16B, the lower end of a board 1c1 serving as a first board and the lower end of a board 1c1 serving as a second board are covered with a support film 20c2 and thus are indicated by broken lines. The video display device 100g may be assembled at an installation site after a support 2c1 including support members 21c1 holding the upper and lower ends of a support film 20c1 and a support 2c2 including support members 21c2 holding the upper and lower ends of the support film 20c2 are transported.

As illustrated in FIG. 16A, at the installation site of the video display device 100g, for example, the support 2c1 and the support 2c2 are first installed to extend in the gravitational direction. In FIG. 16A, the support 2c2 is installed below the support 2c1 in the gravitational direction. The support 2c1 and the support 2c2 are arranged with a gap between the supports in the gravitational direction. The gap between the support member 21c1 in the support 2c1 and the support member 21c2 in the support 2c2 serves as the opening 50. In other words, the support film 20c1 and the support film 20c2 define the opening 50. The support film 20c2 has the opening 5 similar to the opening in the video display device 100a according to Embodiment 1. In this example, the support 2c2 is installed below the support 2c1 in the gravitational direction. In some embodiments, the support 2c2 may be installed above the support 2c1 in the gravitational direction when the support 2c1 and the support 2c2 are installed vertically.

As illustrated in FIG. 16B, the board 1c1 serving as the first board is then installed on the support film 20c1, and a board 1c2 serving as the second board is installed on the support film 20c2. The lower end of the board 1c1 is placed through the opening 50 to be on the non-installation surface of the support film 20b2. The lower end of the board 1c2 is placed through the opening 5 to be on the non-installation surface of the support film 20b2. The video display device 100g is assembled in this manner. In this example, the support 2c1 and the support 2c2 are installed, and then the board 1c1 and the board 1c2 are installed. In some embodiments, the support 2c1 is installed and the board 1c1 is installed on the support 2c1, and then the support 2c2 is installed and the board 1c2 is installed on the support 2c2. In some embodiments, the support 2c2 is installed and the board 1c2 is installed on the support 2c2, and then the support 2c1 is installed and the board 1c2 is installed on the support 2c1.

The video display devices 100f and 100g with the above structures can thus reduce damage to the boards 1b1 and 1b2 and boards 1c1 and 1c2.

The video display devices 100f and 100g including the side frames 8 supporting the support film 20b1 and the support film 20b2 can enhance the strength of the support 2.

The video display devices 100f and 100g including the auxiliary frames 80 supporting the support film 20b1 and the support film 20b2 can further enhance the strength of the support 2.

Either the video display device 100f having the opening 50 defined by the auxiliary frame 80a and the auxiliary frame 80b, or the video display device 100g having the opening 50 defined by the support film 20c1 and the support film 20c2 may be used when the support 2 has an opening.

For the video display device 100g, the board 1c1 and the board 1c2 are installed after the support 2c1 and the support 2c2 are installed. In some embodiments, after the support 2c1 is installed and the board 1c1 is installed on the support film 20c1 in the support 2c1, the support 2c2 may be installed on the lower end of the board 1c1, and the board 1c2 may be installed on the support film 20c2 in the support 2c2.

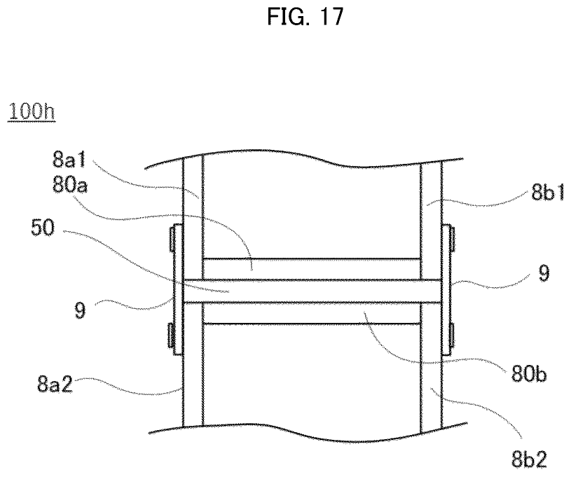

FIG. 17 is a schematic front view of a part of another video display device 100h according to Embodiment 2. The video display device 100f includes two auxiliary frames 80 across two side frames 8. In some embodiments, as illustrated in FIG. 17, the auxiliary frame 80a may connect the ends of a side frame 8a1 and a side frame 8b1, and the auxiliary frame 80b may connect the ends of a side frame 8a2 and a side frame 8b2. This allows, for example, the support 2 (not illustrated in FIG. 17) including the side frame 8a1, the side frame 8b1, and the auxiliary frame 80a and the support 2 (not illustrated FIG. 17) including the side frame 8a2, the side frame 8b2, and the auxiliary frame 80b of the video display device 100h to be assembled at different places to be transported to the installation site.

The auxiliary frame 80a and the auxiliary frame 80b are located to have a gap in between in the gravitational direction. In the video display device 100g, the gap between the support member 21c1 in the support 2c1 and the support member 21c2 in the support 2c2 serves as the opening 50, but in the video display device 100f, the gap between the support 2 including the auxiliary frame 80a and the support 2 including the auxiliary frame 80b serves as the opening 50.

As illustrated in FIG. 17, the side frame 8a1 and the side frame 8a2 may be connected and fixed to each other with a fastener 9, and the side frame 8b1 and the side frame 8b2 may be connected and fixed to each other with a fastener 9. This structure can enhance the strength of the support 2. The fasteners 9 may be, for example, plates. Wires or chains may be used as the fasteners 9 to connect the side frame 8a1 and the side frame 8a2 to each other and the side frame 8b1 and the side frame 8b2 to each other to allow the side frames 8a1 and 8a2 and the side frames 8b1 and 8b2 to move independently. This structure can enhance the strength against a wind load.

In one or more embodiments of the present disclosure, for waterproofing, the board 1, or the board 1 and the support 2 may be coated with a waterproof resin, or have a bonded waterproof film. When the board 1 alone is coated with a waterproof resin or has a bonded waterproof film, both the front and back surfaces of the board 1 are to be coated with a waterproof resin or have bonded waterproof films.

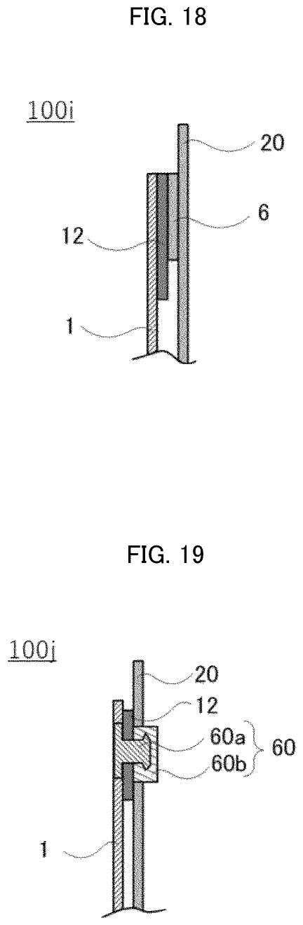

In the example of FIG. 4, the upper end of the board 1 is fixed to the support film 20 with the adhesive 6, but may be fixed in another manner. FIG. 18 is a cross-sectional side view of a part of a video display device 100i according to an embodiment of the present disclosure. When the upper end of the board 1 is fixed to the support film 20 with the adhesive 6 with a stiffener 12 located at the upper end of the board 1, the fixed portion enhances the strength. The upper end of the board 1 may be fixed to the support film 20 with, for example, a hook-and-loop fastener or a magnet. Another method for fixing the upper end of the board 1 to the support film 20 is described below.

FIG. 19 is a cross-sectional side view of a part of a video display device 100j according to an embodiment of the present disclosure. In the video display device 100j illustrated in FIG. 19, the upper end of the board 1 is fixed to the support film 20 with a snap button 60. The snap button 60 includes a protruding stud 60a and a recessed socket 60b. The snap button 60 fastens the upper end of the board 1 to the support film 20 by interlocking the protruding stud 60a and the recessed socket 60b. Thus, the upper end of the board 1 can be fixed to the support film 20 in a simple manner. In the example of FIG. 19, the board 1 includes the stud 60a, and the support film 20 includes the socket 60b. In some embodiments, the board 1 may include the socket 60b, and the support film 20 may include the stud 60a. As illustrated in FIG. 19, the stiffener 12 located between the upper end of the board 1 and the support film 20 can enhance the strength of the fixed portion.

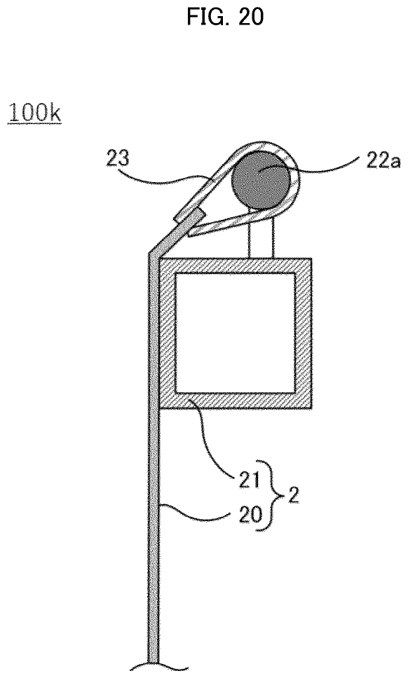

A method for installing the support film 20 on the support members 21 is now described. FIG. 20 is a cross-sectional side view of a part of a video display device 100k according to an embodiment of the present disclosure. The support member 21 illustrated in FIG. 20 is at the upper end of the support film 20. The support member 21 includes a support film anchor 22a that extends in a direction opposite to the direction in which the support film 20 extends. More specifically, the support film anchor 22a extends above the upper portion of the support 2. The support film 20 has, for example, a hole at the upper end. The hole in the support film 20 receives an attachment rope 23. When the attachment rope 23 attached to the support film 20 is fixed to the support film anchor 22a, the support film 20 is installed on the support member 21. In this manner, the support film 20 can be installed on the support member 21 in a simple manner.

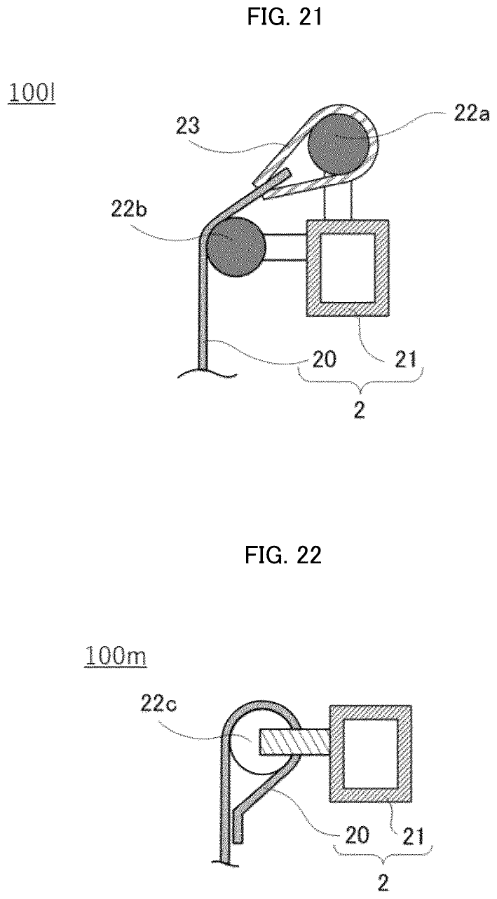

FIG. 21 is a cross-sectional side view of a part of a video display device 100l according to an embodiment of the present disclosure. The support member 21 illustrated in FIG. 21 is at the upper end of the support film 20. The support member 21 includes the support film anchor 22a described above and a support film anchor 22b extending from the support member 21 toward the support film 20. When the attachment rope 23 attached to the support film 20 is fixed to the support film anchor 22a, the support film 20 is installed on the support member 21. The support film anchor 22b in contact with the non-installation surface of the support film 20 can reduce the likelihood of contact of the support film 20 with the corner of the support member 21, thus reducing breakage of the support film 20.

FIG. 22 is a cross-sectional side view of a part of a video display device 100m according to an embodiment of the present disclosure. The support member 21 illustrated in FIG. 22 is at the upper end of the support film 20. The support member 21 includes a support film anchor 22c extending from the support member 21 to the support film 20. The upper end of the support film 20 is wound around the support film anchor 22c and fixed to the non-installation surface of the support film 20. In this manner, the support film 20 can be installed on the support members 21 in a simple manner.

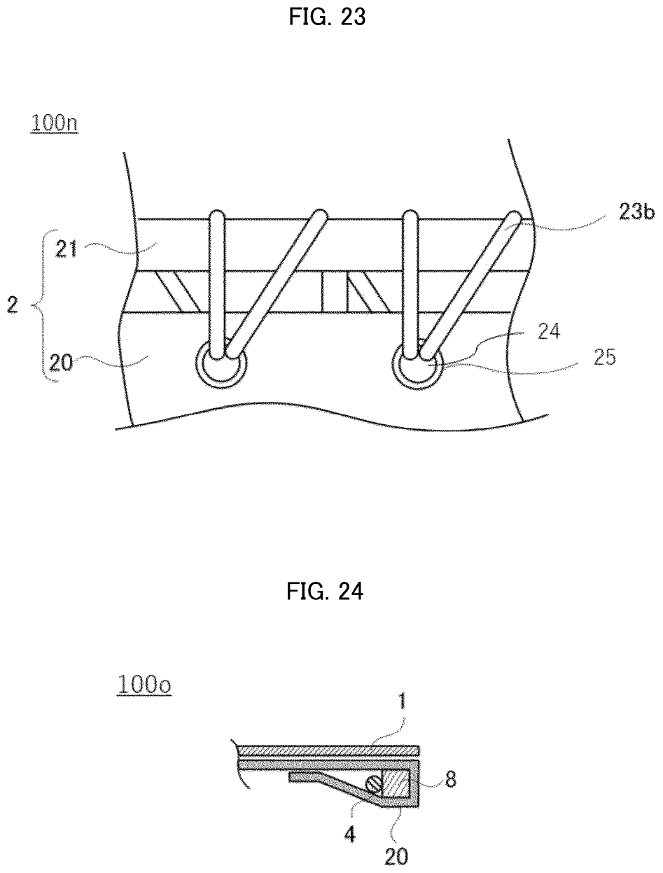

FIG. 23 is a schematic front view of a part of a video display device 100n according to an embodiment of the present disclosure. The support film 20 has holes 24 at the upper end. In the video display device 100n illustrated in FIG. 23, an attachment rope 23b is placed through the holes 24 in the support film 20 to install the support film 20 on the support member 21. The support film 20 can thus be installed on the support member 21 in a simple manner. As illustrated in FIG. 23, each hole 24 in the support film 20 may be reinforced with an eyelet 25. In the example, the support film 20 is directly installed on the support member 21. In some embodiments, the support member 21 may include a support film anchor 22, and a support film 20 may be installed on the support member 21 with the support film anchor 22 in between.

A method for installing the side frames 8 on the support film 20 is now described. FIG. 24 is a cross-sectional view of a part of a video display device 100o according to an embodiment of the present disclosure. In the video display device 100o illustrated in FIG. 24, the left and right edges of the support film 20 wrap and cover the side frames 8 and are fixed to the non-installation surface of the support film 20. When the cable 4 is placed in a space defined by the support film 20 and each side frame 8, the cable 4 is covered with the support film 20. Thus, the cable 4 can have enhanced resistance against environment, such as water resistance and light resistance.

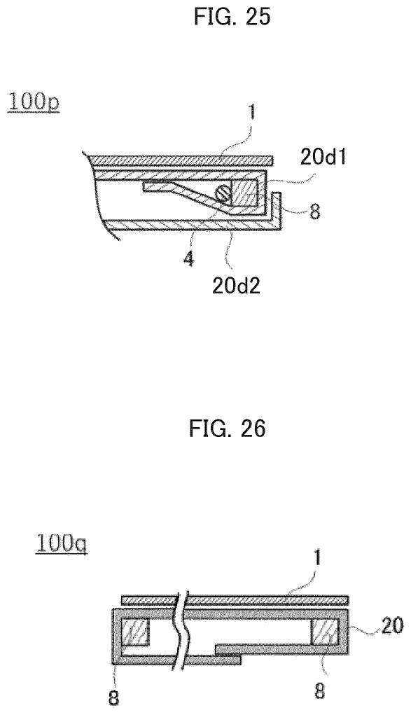

FIG. 25 is a cross-sectional view of a part of a video display device 100p according to an embodiment of the present disclosure. As in the video display device 100o illustrated in FIG. 24, the video display device 100 illustrated in FIG. 25 has the left and right edges of a support film 20d1 wrapping and covering the side frames 8 and fixed to the non-installation surface of the support film 20d1. The video display device 100p illustrated in FIG. 25 also includes a support film 20d2 on the non-installation surface of the support film 20d1 to cover the non-installation surface of the support film 20d1 as well as the left and right side frames 8 and the cables 4 covered with the support film 20d1. This structure enhances the waterproofness of the non-installation surface. The support film 20d2 covers the lower end of each board 1 installed on the non-installation surface of the support film 20d1. Thus, the video display device 100p illustrated in FIG. 25 enhances the appearance. To mount components on the surface of the board 1 receiving the support film 20d1, holes may be formed in the support film 20d1 corresponding to the positions of the components to allow the components on the board 1 to extend through the holes in the support film 20d1 to the non-installation surface of the support film 20d1. In this state, the support film 20d2 covering the non-installation surface of the support film 20d1 can enhance the waterproofness of the components mounted adjacent to the support film 20d1 of the board 1 and enhance the appearance.

FIG. 26 is a cross-sectional view of a part of a video display device 100q according to an embodiment of the present disclosure. In the video display device 100q illustrated in FIG. 26, the support film 20 wraps and covers the side frames 8, and the left and right edges of the support film 20 are fixed to each other on the non-installation surface side of the support film 20. Thus, the single support film 20 can define a space between the side frames 8. The video display device 100q illustrated in FIG. 26 can thus enhance the waterproofness and the appearance when, for example, the cables 4 are installed adjacent to the non-installation surface of the support film 20 or the components on the board 1 extend through the holes in the support film 20 toward the non-installation surface of the support film 20 as described above.

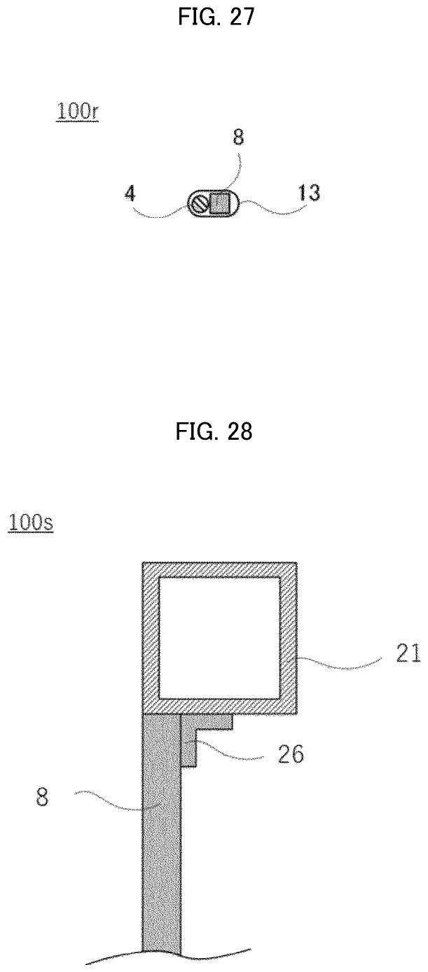

FIG. 27 is a cross-sectional view of a part of a video display device 100r according to an embodiment of the present disclosure. In the video display device 100r illustrated in FIG. 27, the cable 4 may be fixed to the side frame 8 with a binder 13. The video display device 100r illustrated in FIG. 27 with this structure can support the weight of the cable 4 with the side frame 8. The video display device 100r can reduce detachment of the cable 4 from the board 1 and reduce the load on the board 1. The video display device 100r illustrated in FIG. 27 can also enhance the resistance of the cable 4 against wind or other loads.

FIG. 28 is a cross-sectional side view of a part of a video display device 100s according to an embodiment of the present disclosure. In the video display device 100s illustrated in FIG. 28, each side frame 8 is fixed to the support member 21 with a bracket 26. The bracket 26 may be fixed to the support member 21 by fastening with, for example, a bolt. Thus, the video display device 100s illustrated in FIG. 28 can enhance the strength of the support 2. Although FIG. 28 illustrates a method for fixing the side frame 8 to the support member 21 with the bracket 26 in the video display device 100s, the side frame 8 may be fixed to the support member 21 directly with, for example, a bolt without using the bracket 26.

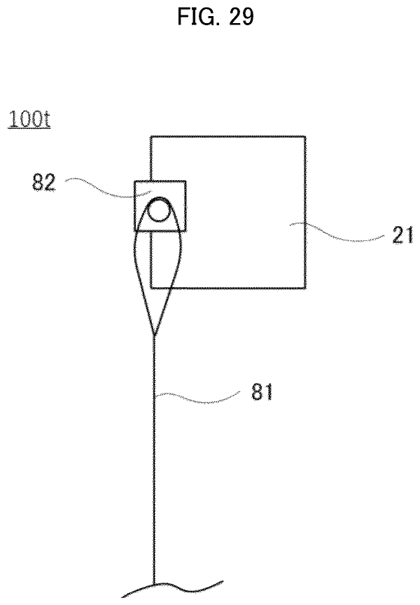

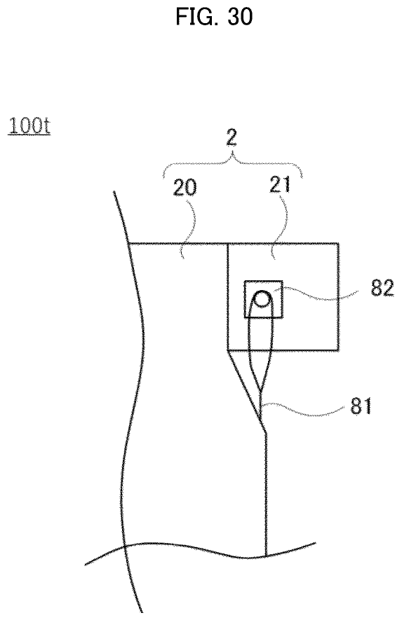

FIGS. 29 and 30 are schematic front views of a part of a video display device 100t according to an embodiment of the present disclosure. FIG. 30 illustrates the video display device 100t in FIG. 29 on which the support film 20 is installed. The support member 21 in the video display device 100t illustrated in FIGS. 29 and 30 includes a wire hook 82 on which a wire 81 serving as a side support is hooked. The video display device 100t illustrated in FIGS. 29 and 30 includes the wire 81 at each of the left and right edges of the support film 20 to support the support film 20. Thus, the support 2 in the video display device 100t illustrated in FIGS. 29 and 30 is lightweight, and the video display device 100t is lightweight.

In one or more embodiments of the present disclosure, a single board 1 may include multiple video displays. In this case, multiple cables 4 are connected to the single board 1 to supply power and video signals to the respective video displays. When power is supplied to an elongated board 1 for a large screen through a single cable, a wide wiring pattern is to be used to supply a large current to the board 1. This largely restricts the wiring pattern, as well as, for example, enlarging the board 1 or using more layers. However, multiple cables 4 connected to a single board 1 supply power and video signals to the respective video displays to reduce the amount of current and the pattern width, thus decreasing the size of the board 1. This also increases the packaging density of the light emitter 10.

In one or more embodiments of the present disclosure, the support members 21 may be parts of a structure in which any of the video display devices 100a to 100t (collectively referred to as a video display device 100) is installed, or may be attached to the structure. Examples of the structure include a signboard frame installed on a utility pole and a beam for installing a signboard at a stadium or at a commercial institution.

### REFERENCE SIGNS LIST

1 Board
2 Support
3 Power controller
4 Cable
5, 50 Opening
6 Adhesive
7 Weight
8 Side frame
9 Fastener
10 Light emitter
11 Recess
12 Stiffener
13 Binder
20 Support film
21 Support member
22 Support film anchor
23 Rope
24 Hole
25 Eyelet
26 Bracket
51 Support film stiffener
60 Snap button
80 Auxiliary frame
81 Wire
100 Video display device

1. A video display device, comprising:
a board on which light emitters to emit light are mounted, the board being installable to extend in a gravitational direction; and
a support including a support film receiving the board, the support having an opening, wherein
the support film has an installation surface on which the board is installed and a non-installation surface opposite to the installation surface, and the opening in the support penetrates the support from the installation surface to the non-installation surface of the support film,
the board has an upper end fixed to the installation surface of the support film and a lower end extending through the opening and placed on the non-installation surface of the support film, and
the opening is located in the support film.

2. (canceled)

3. The video display device according to claim 1, wherein
the board has, at a left edge and a right edge of the board, recesses extending laterally inward in the board,
the recesses in the board are aligned with the opening in the support film, and
the support film is located in the recesses at the opening.

4. A video display device comprising:
a board on which light emitters to emit light are mounted, the board being installable to extend in a gravitational direction; and
a support including a support film receiving the board, the support having an opening, wherein
the support film has an installation surface on which the board is installed and a non-installation surface opposite to the installation surface, and the opening in the support penetrates the support from the installation surface to the non-installation surface of the support film,
the board has an upper end fixed to the installation surface of the support film and a lower end extending through the opening and placed on the non-installation surface of the support film,
the support includes a first support film and a second support film, and the first support film has a lower end facing an upper end of the second support film, and
the support has a first opening and a second opening, the first opening is defined by the lower end of the first support film and the upper end of the second support film, and the second support film has the second opening.

5. (canceled)

6. The video display device according to claim 1, wherein
the board is flexible.

7. The video display device according to claim 1, further comprising:
a retainer at the lower end of the board.

8. The video display device according to claim 1, further comprising:
a support film stiffener at a periphery of the opening.

9. The video display device according to claim 1, wherein
the support includes a side support on the non-installation surface of the support film, and the side support extends in a direction in which the support film extends.

10. The video display device according to claim 9, wherein
the support includes a pair of the side supports at a left edge and a right edge of the support film,
the support includes an auxiliary frame on the non-installation surface of the support film to connect the pair of side supports, and
the auxiliary frame extends in a direction crossing a direction in which the pair of side supports extend.

11. A method for assembling a video display device, the method comprising:
installing a first support including a first support film to extend in a gravitational direction;
installing, below the first support in the gravitational direction, a second support including a second support film to extend in the gravitational direction and to cause an upper end of the second support film to face a lower end of the first support film across a first opening, the first support film having an installation surface on which a first board is installable and a non-installation surface opposite to the installation surface, wherein the first opening defined by the first support and the second support penetrates from the installation surface to the non-installation surface, the second support film has an installation surface on which a second board is installable and a non-installation surface opposite to the installation surface, and the second support film has a second opening penetrating the second support film from the installation surface to the non-installation surface;
fixing an upper end of the first board to the first support film, and placing a lower end of the first board through the first opening to be on the non-installation surface of the second support film; and
fixing an upper end of the second board to the second support film, and placing a lower end of the second board through the second opening to be on the non-installation surface of the second support film.

12. (canceled)

13. The video display device according to claim 3, wherein
the board is flexible.

14. The video display device according to claim 4, wherein
the board is flexible.

15. The video display device according to claim 3, further comprising:
a retainer at the lower end of the board.

16. The video display device according to claim 4, further comprising:
a retainer at the lower end of the board.

17. The video display device according to claim 6, further comprising:
a retainer at the lower end of the board.

18. The video display device according to claim 3, further comprising:
a support film stiffener at a periphery of the opening.

19. The video display device according to claim 4, further comprising:
a support film stiffener at a periphery of the opening.

20. The video display device according to claim 6, further comprising:
a support film stiffener at a periphery of the opening.

21. The video display device according to claim 7, further comprising:
a support film stiffener at a periphery of the opening.

22. The video display device according to claim 3, wherein
the support includes a side support on the non-installation surface of the support film, and the side support extends in a direction in which the support film extends.

23. The video display device according to claim 4, wherein
the support includes a side support on the non-installation surface of the support film, and the side support extends in a direction in which the support film extends.
